(19) United States
(12) Patent Application Publication
(10) Pub. No.: US 2026/0265014 A1
(43) Pub. Date: Sep. 10, 2026

(54) MEDIUM LOADING DEVICE

(71) Applicant: SEIKO EPSON CORPORATION, Tokyo (JP)

(72) Inventors: Shun ITO, MATSUMOTO-SHI (JP); Atsuhiko TAKEUCHI, MATSUMOTO-SHI (JP)

(21) Appl. No.: 19/554,749

(22) Filed: Mar. 3, 2026

(30) Foreign Application Priority Data
Mar. 5, 2025 (JP) 2025-034361

(51) Int. Cl. B65H 31/20; B41J 15/04; B41J 29/02

(52) U.S. Cl. CPC B65H 31/20; B41J 15/04; B41J 29/02; B65H 2301/4212; B65H 2801/15

(57) ABSTRACT

A medium loading device includes a loading unit in which a medium is loaded on a support surface extending in a discharge direction, an upper frame extending in an X-axis direction, and a lower frame extending in the X-axis direction. The loading unit includes an upstream unit including an upstream side and supported by the upper frame and a downstream unit including a downstream side and supported by the lower frame. When a distance orthogonal to the discharge and X-axis directions is set as an up-down direction, a distance in the up-down direction between the support surface of the downstream unit and the lower frame is longer than a distance in the up-down direction between the support surface of the upstream unit and the upper frame. The downstream unit is supported by the lower frame from a lower side via a supported section of the downstream unit.

The present application is based on, and claims priority from JP Application Serial Number 2025-034361, filed March 5, 2025, the disclosure of which is hereby incorporated by reference herein in its entirety.

### BACKGROUND

### 1. Technical Field

The present disclosure relates to a medium loading device.

### 2. Related Art

JP-A-2023-093896 discloses a medium placement device on which a plurality of media discharged from a discharge unit of a processing device can be loaded. The medium placement device includes, in the width direction intersecting a discharge direction of the media, a plurality of support units that support the media discharged from the discharge unit on support surfaces from the lower side in the direction of gravity. The support units extend in the discharge direction and are inclined to be lower in the direction of gravity from the upstream side to the downstream side in the discharge direction. The plurality of support units are provided at intervals in the width direction by being coupled to a member extending in the width direction intersecting the discharge direction. The member extending in the width direction extends to both outer sides of the plurality of support units in the width direction.

JP-A-2023-093896 is an example of the related art.

However, in the medium placement device disclosed in JP-A-2023-093896, since the member extending in the width direction extends to both the outer sides of the plurality of support units, the leading end of a medium sometimes curls because the ends of the discharged medium come into contact with both the outer sides of the plurality of support units. For that reason, when the medium curls on the support units and floats above the support surfaces, a medium loading failure is likely to occur in the support units.

### SUMMARY

According to an aspect of the present disclosure, there is provided a medium loading device on which a medium discharged from a processing device in a discharge direction is loaded, the medium loading device including: a loading unit in which the medium is loaded on a support surface that supports the medium and extends in the discharge direction to suspend, downward from the support surface, at least one end of the medium in a width direction intersecting the discharge direction; a pair of legs disposed on both sides in the width direction with respect to the loading unit; an upper frame extending in the width direction and connecting the pair of legs to each other; and a lower frame extending in the width direction and connecting the pair of legs to each other, in which the lower frame connects the pair of legs to each other at a position downstream in the discharge direction with respect to a position where the upper frame connects the pair of legs to each other, the loading unit includes: an upstream unit including an upstream side in the discharge direction in the support surface and supported by the upper frame; and a downstream unit including a downstream side in the discharge direction in the support surface and supported by the lower frame, when a distance orthogonal to the discharge direction and the width direction is set as an up-down direction, a distance in the up-down direction between the support surface of the downstream unit and the lower frame is longer than a distance in the up-down direction between the support surface of the upstream unit and the upper frame, and the downstream unit is supported by the lower frame from a lower side via a supported section of the downstream unit.

### BRIEF DESCRIPTION OF THE DRAWINGS

FIG. 1 is a perspective view of a recording device to which a medium loading device according to an embodiment can be coupled.

FIG. 2 is a perspective view illustrating a state in which the medium loading device according to the embodiment is coupled to the recording device.

FIG. 3 is a side view of the medium loading device according to the embodiment.

FIG. 4 is a perspective view illustrating a schematic configuration of the medium loading device according to the embodiment.

FIG. 5 is a side view illustrating a schematic configuration of the medium loading device according to the embodiment.

FIG. 6 is a top view illustrating a schematic configuration of the medium loading device according to the embodiment.

FIG. 7 is a cross-sectional view illustrating an S7-S7 cross section illustrated in FIG. 5.

FIG. 8 is a partial perspective view illustrating a schematic configuration around a receiving unit of a lower frame.

FIG. 9 is a side view illustrating a schematic configuration of the medium loading device in which a lower loading unit is present at a housing position.

### DESCRIPTION OF EMBODIMENTS

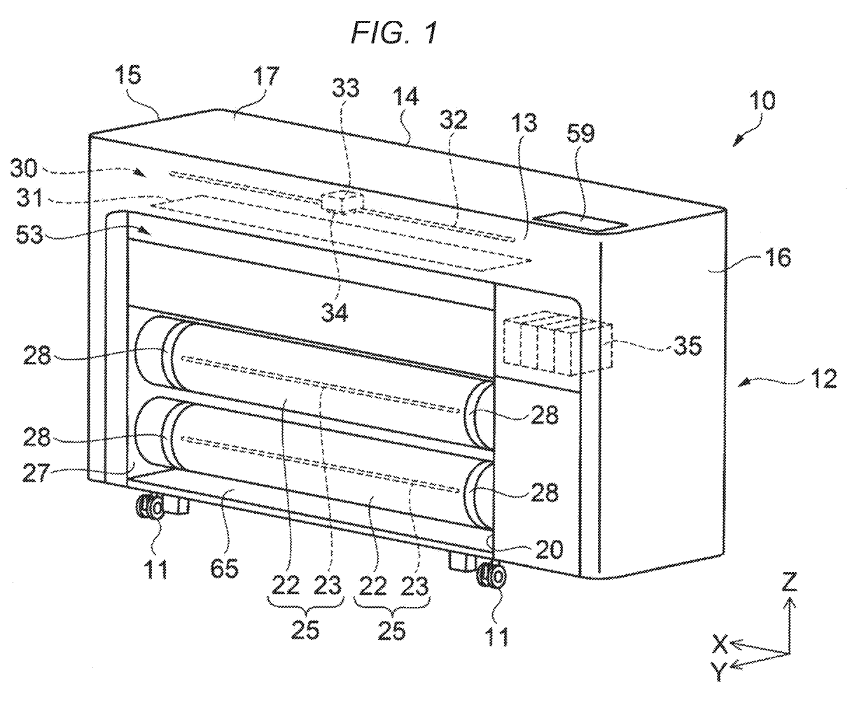

Hereinafter, a medium loading device 100 according to the present disclosure is explained with reference to the drawings. The medium loading device 100 in the present embodiment is a medium loading device capable of loading a plurality of media 22 discharged from a discharge unit 53 of the recording device 10 illustrated in FIG. 1. The recording device 10 is an example of a processing device. The medium loading device 100 in the present embodiment can be coupled to the recording device 10 but may be able to be coupled to a processing device other than the recording device, such as an image reading device.

In the figures, the same members are denoted by the same reference numerals and signs and redundant explanation of the members is sometimes omitted. The terms "same", "identical", and "simultaneous" described in the present specification do not indicate only being completely the same.

For example, the terms "same", "identical", and "simultaneous" described in the present specification mean being the same when measurement errors are considered. For example, the terms "same", "identical", and "simultaneous" described in the present specification mean being the same considering manufacturing variations of members.

For example, the terms "same", "identical", and "simultaneous" described in the present specification mean being the same in a range in which functions are not spoiled. Therefore, for example, "both dimensions are the same" indicates that the difference between both the dimensions is ±5% or less, particularly, preferably ±3% or less of one dimension when measurement errors and manufacturing variations of members are considered.

In the figures, X, Y, and Z represent three spatial axes orthogonal to one another. In the present specification, directions along these axes are represented as an X-axis direction, a Y-axis direction, and a Z-axis direction. When directions are specified, a positive direction is represented as "+" and a negative direction is represented as "-", the positive and negative signs are used together for direction, and a direction pointed by an arrow is described as a + direction and the direction opposite to the direction pointed by the arrow is described as a - direction in the figures.

The Z-axis direction indicates the direction of gravity, the +Z direction indicates a vertically upward direction, and the -Z direction indicates a vertically downward direction. A plane including the X axis and the Y axis is described as an X-Y plane, a plane including the X axis and the Z axis is described as an X-Z plane, and a plane including the Y axis and the Z axis is described as a Y-Z plane. The X-Y plane is the horizontal plane. The three spatial axes X, Y, and Z, which do not limit the positive direction and the negative direction, are described as the X axis, the Y axis, and the Z axis.

The X-axis direction is the horizontal direction along an installation surface, which is the horizontal plane, on which a recording device 10 is installed. The X-axis direction is the width direction of the recording device 10 and is the width direction of a medium 22 on which recording is performed. The Y-axis direction is the horizontal direction along the installation surface on which the recording device 10 is installed. The Y-axis direction is the depth direction of the recording device 10.

The +Y direction is a direction from a rear wall 14 toward a front wall 13 of the recording device 10. The -Y direction is a direction from the front wall 13 toward the rear wall 14 of the recording device 10.

A first side wall 15, which is a side wall in the +X direction, is a left side wall of the recording device 10. A second side wall 16, which is a side wall in the -X direction, is a right side wall of the recording device 10. The Z-axis direction is the normal direction with respect to the installation surface on which the recording device 10 is installed and is the height direction of the recording device 10.

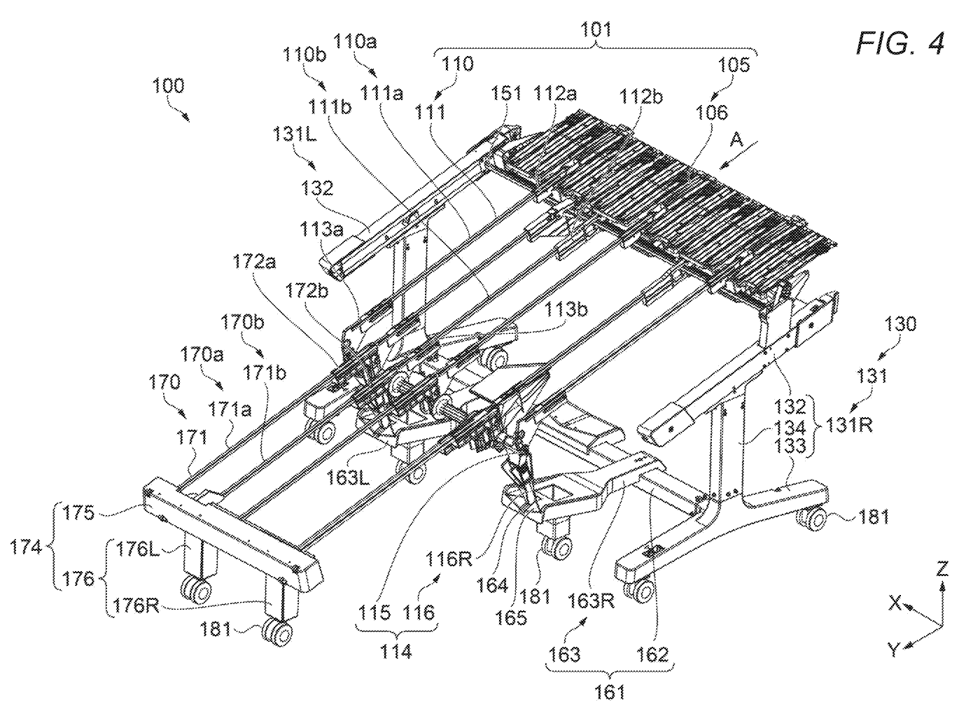

In the following explanation, a direction in which the medium 22 moves by being conveyed or discharged is sometimes referred to as "downstream" and a direction opposite to the direction is sometimes referred to as "upstream". For convenience of illustration, the sizes of members are sometimes different from actual sizes. In FIGS. 4 to 7, illustration of a pressing unit 120 is omitted for explanation.

### Embodiment

First, a schematic configuration of the recording device 10 according to an embodiment is explained. As illustrated in FIG. 1, the recording device 10 is installed via casters 11. The recording device 10 includes a housing 12 having a substantially rectangular parallelepiped shape long in the X-axis direction. The housing 12 includes the front wall 13, the rear wall 14, the first side wall 15, the second side wall 16, and an upper wall 17.

In the recording device 10, a direction in which a base frame 65 and the upper wall 17 face each other is the height direction of the recording device 10. A direction in which the first side wall 15 and the second side wall 16 face each other is the width direction of the recording device 10. A direction in which the front wall 13 and the rear wall 14 face each other is the depth direction of the recording device 10.

A recording unit 30 including a recording head 34 that performs recording on the medium 22 and a housing unit 20 that houses a roll body 25 obtained by winding the medium 22 in a cylindrical shape are provided on the inside of the housing 12. Further, a conveyance unit (not illustrated) that conveys the medium 22, a cutting unit (not illustrated) that cuts the medium 22, and the like are provided on the inside of the housing 12.

A plurality of openings are provided in the front wall 13 of the housing 12. In the front wall 13, a roll body housing port 27 for housing the roll body 25 is provided at a position on the -Z direction side close to the base frame 65 in the Z axis direction. In the front wall 13, a discharge unit 53 for discharging the recorded medium 22 is provided at a position in the +Z direction of the roll body housing port 27.

The cylindrical roll body 25 formed by winding the long medium 22 around a core member 23 is housed in the housing unit 20 to be detachably from the roll body housing port 27. In the present embodiment, the housing unit 20 is configured to be capable of housing two roll bodies 25 long in the X-axis direction in a state of being disposed side by side in the Z-axis direction.

A pair of holding members 28 that holds the roll body 25 to be capable of rotating with respect to the housing unit 20 is attached to both ends of the roll body 25. When the roll body 25 is rotationally driven, the medium 22 wound around the roll body 25 is delivered in the -Y direction toward the rear wall 14 side in the housing 12.

The medium 22 delivered toward the rear wall 14 side is conveyed by the conveyance unit to be conveyed in the +Y direction toward a support stand 31 while changing the direction to the +Z direction on the rear wall 14 side. The medium 22 conveyed to the support stand 31 by the conveyance unit is conveyed on the support stand 31 in the +Y direction toward the front wall 13 side.

The recording head 34 is mounted on a carriage 33 that moves along a guide member 32. The recording head 34 is located on the support stand 31 side with respect to the carriage 33. The recording head 34 is configured to be capable of reciprocating along the guide member 32 together with the carriage 33.

The recording head 34 is connected to, by a not-illustrated tube having flexibility, a cartridge 35 that stores ink. The recording head 34 performs recording on the medium 22 by ejecting the ink onto the medium 22 supported by the support stand 31 while moving in the X-axis direction. The recorded medium 22 is cut by a not-illustrated cutting unit.

The recording device 10 includes an input unit 59. The input unit 59 is provided on the upper surface of the upper wall 17 of the housing 12. The input unit 59 includes, for example, a liquid crystal display device including a touch panel and is used when a user inputs various information.

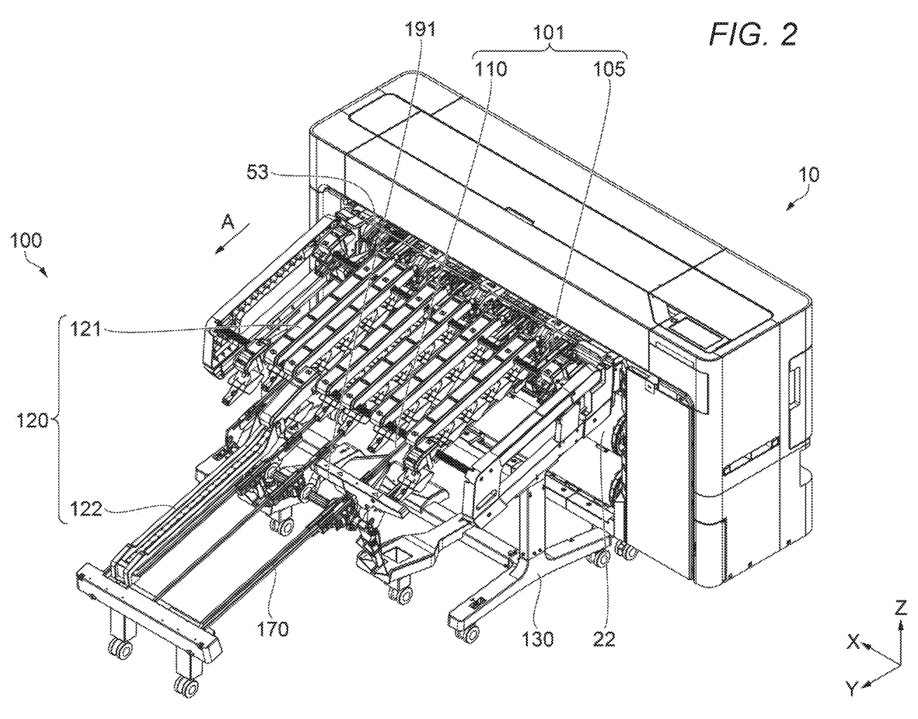

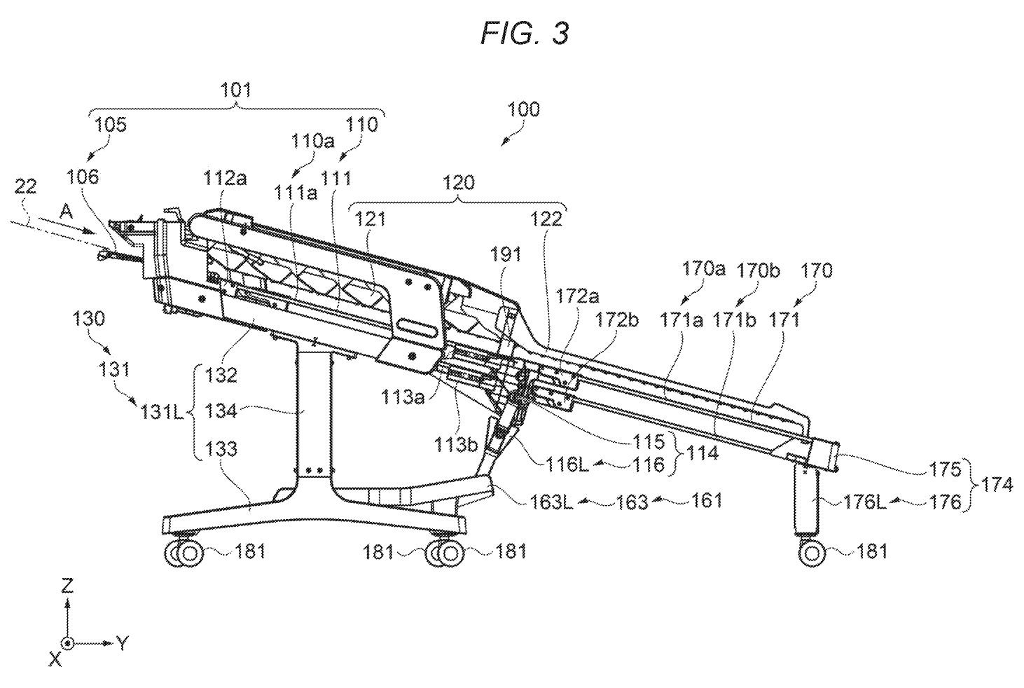

Hereinafter, the medium loading device 100 according to the present disclosure is explained with reference to FIGS. 2 to 9. As illustrated in FIGS. 2 and 3, the medium loading device 100 in the present embodiment is provided to be capable of being coupled to the recording device 10. The medium loading device 100 has a configuration in which a plurality of media 22 (see FIG. 3) discharged from the discharge unit 53 of the recording device 10 in a discharge direction A can be loaded on support surfaces 106 and 111 (see FIG. 3) of the loading unit 101. In the loading unit 101, the discharged medium 22 can be loaded to suspend, downward from the support surfaces 106 and 111, at least one end of the medium 22 in the width direction intersecting the discharge direction A.

The medium loading device 100 in the present embodiment includes an upstream unit 105 and a downstream unit 110 configuring the loading unit 101, a leg unit 130, a downstream loading unit 170, a pressing unit 120, and an edge guide 191.

As illustrated in FIGS. 3 and 4, the upstream unit 105 supports, on the support surface 106 from below, the medium 22 discharged downstream in the discharge direction A from the discharge unit 53. The upstream unit 105 is attached to an upper frame 151 (see FIG. 4) configuring the leg unit 130. In the upstream unit 105, the medium 22 is often halfway in being discharged from the discharge unit 53. For this reason, the medium 22 is pushed out downstream even when the end in the width direction of the medium 22 comes into contact with the upper frame 151 and is loaded again further on the downstream side than the upper frame 151 such that the end in the width direction of the medium 22 hangs downward.

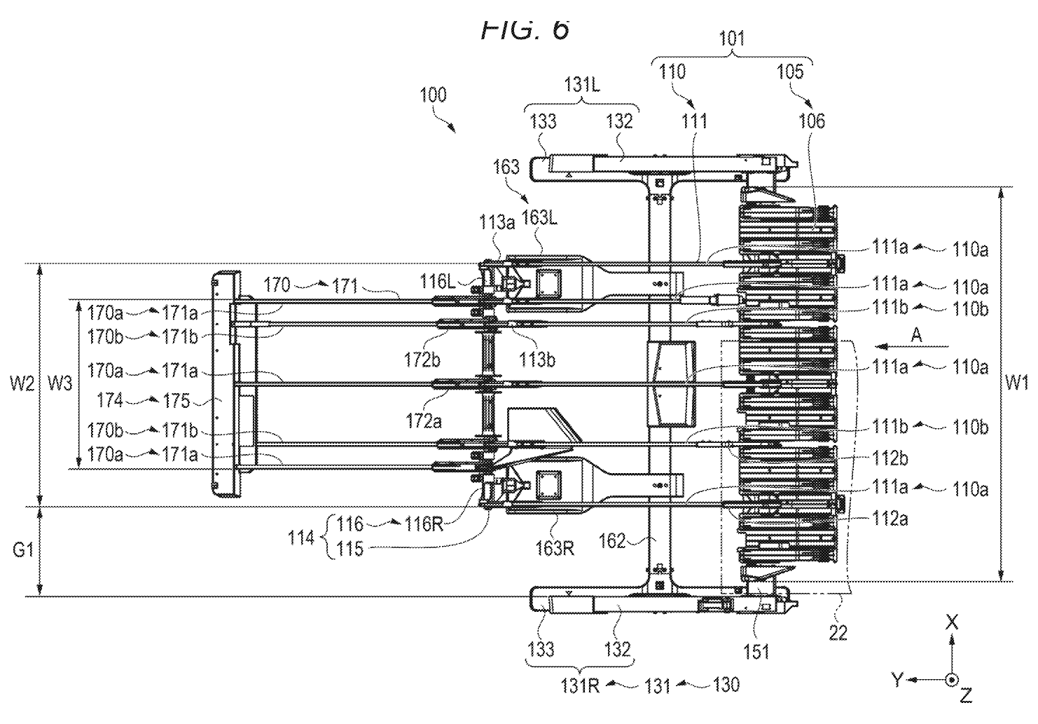

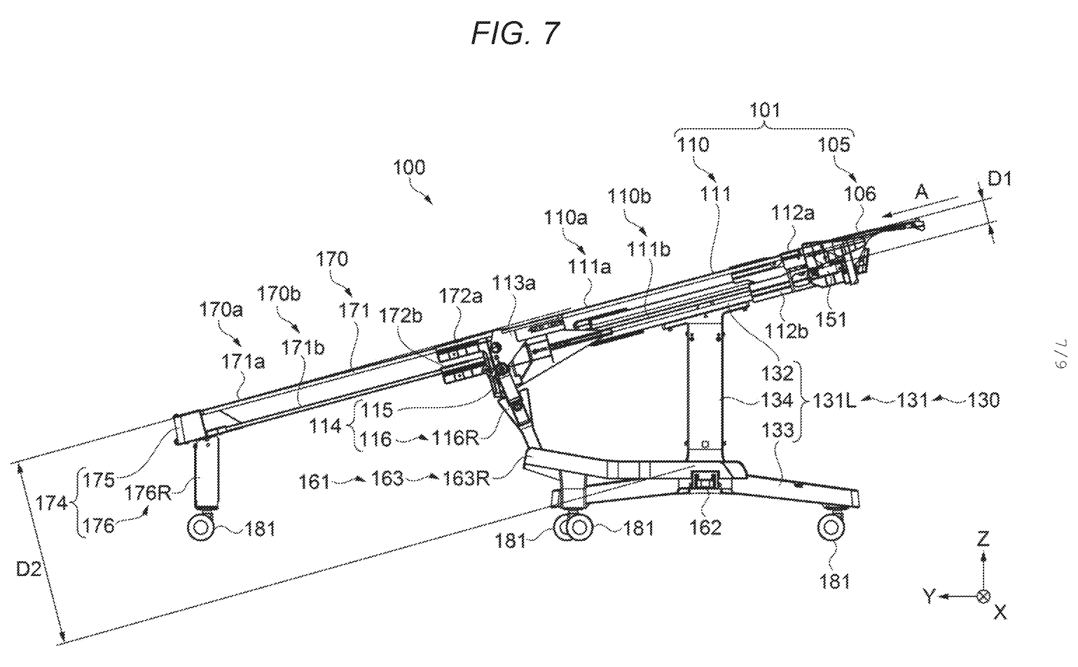

As illustrated in FIGS. 3 and 7, the support surface 106 of the upstream unit 105 is inclined in a direction in which the downstream side in the discharge direction A is located further in the -Z direction than the upstream side. A dimension W1 (see FIG. 6) between both ends in the X-axis direction of the support surface 106 that supports the medium 22 is set to be smaller than a width dimension of the largest medium 22 (not illustrated) among the discharged media 22.

The downstream unit 110 is continuously provided downstream in the discharge direction A of the upstream unit 105 and supports, on the support surface 111 from below, the medium 22 moving downstream in the discharge direction A from the upstream unit 105. The downstream unit 110 includes a plurality of medium support units 110a and 110b configuring the support surface 111 and a connecting unit 114.

The plurality of medium support units 110a and 110b have a square bar shape extending in the discharge direction A. As illustrated in FIGS. 4, 5, and 6, the plurality of medium support units 110a and 110b are provided at intervals in the X-axis direction. The X-axis direction is an example of the width direction intersecting the discharge direction A of the medium 22.

As illustrated in FIG. 6, in the present embodiment, four medium support units 110a and two medium support units 110b are provided at intervals in the X-axis direction. Three medium support units 110a among the four medium support units 110a are disposed side by side in the X axis direction and are disposed at positions in the center and at both the ends of the downstream unit 110 in the X axis direction.

One medium support unit 110b of the two medium support units 110b is disposed, in the X axis direction, at the center between the medium support unit 110a at the center and the medium support unit 110a at the end in the -X direction.

The other medium support unit 110b of the two medium support units 110b is disposed, in the X axis direction, at the center between the medium support unit 110a at the center and the medium support unit 110a at the end in the +X direction.

The remaining medium support unit 110a among the four medium support units 110a is disposed, in the X axis direction, between the medium support unit 110a at the end in the +X direction and the other medium support unit 110b.

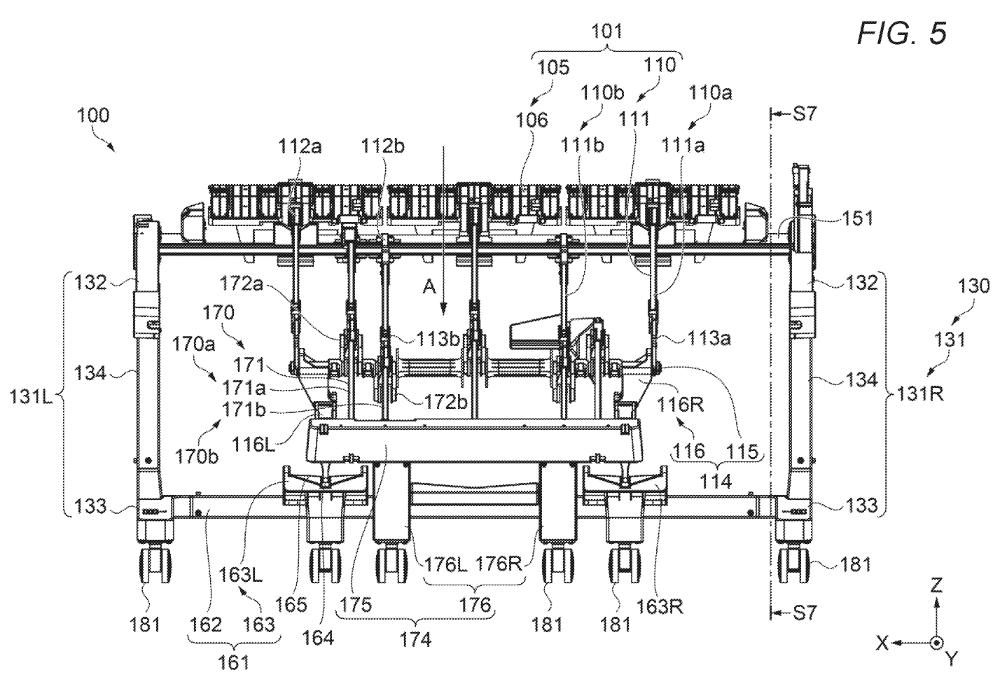

As illustrated in FIGS. 5, 6 and 7, the support surface 111 of the downstream unit 110 includes a support surface 111a, which is a surface on the +Z direction side, of the medium support unit 110a and a support surface 111b, which is a surface on the +Z direction side, of the medium support unit 110b.

As illustrated in FIG. 7, the support surface 111b of the medium support unit 110b is located further on the -Z direction side than the support surface 111a of the medium support unit 110a when viewed from a direction in the X-axis direction.

The medium support units 110a and 110b and the support surfaces 111a and 111b of the medium support units 110a and 110b extend in the discharge direction A and are inclined in a direction in which the downstream side is located further in the -Z direction than the upstream side in the discharge direction A.

As explained above, the support surfaces 106 and 111 of the loading unit 101 in the present embodiment extend in the discharge direction A inclined in a direction in which the downstream side is located further in the -Z direction than the upstream side. For this reason, the medium 22 can be moved using the gravity. The medium 22 can be efficiently moved without using power or the like.

An inclination angle of the support surfaces 106 and 111 with respect to the horizontal plane is set, for example, between 10 degrees and 30 degrees. In the present embodiment, the inclination angle of the support surfaces 106 and 111 with respect to the horizontal plane is set to 15 degrees.

In the downstream unit 110 of the loading unit 101, the medium support unit 110a and the medium support unit 110b are substantially alternately disposed at intervals in the X-axis direction. By alternately disposing the medium support units 110a and 110b having the support surfaces 111a and 111b at different positions in the Z-axis direction, the downstream unit 110 of the loading unit 101 can support the medium 22 sent from upstream to change into a wavy shape, that is, a so-called corrugated shape when viewed from a direction in the discharge direction A.

Since the rigidity of the medium 22 is improved by changing the medium 22 sent from upstream into the corrugated shape, it is possible to suppress, in the discharge direction A, deterioration in conveyance due to deformation such as bending of the medium 22. Accordingly, it is possible to prevent the conveyed medium 22 from being caught by the support surface 111 or the medium 22 already loaded on the support surface 111. Thus, various types of media 22 can be suitably loaded on the loading unit 101 in the present embodiment without using power or the like.

As illustrated in FIG. 6, the end in the -X direction of the support surface 111 of the downstream unit 110 is located on the +X direction side with respect to the end in the -X direction of the support surface 106 of the upstream unit 105. The end in the -X direction of the support surface 111 of the downstream unit 110 is the end in the -X direction of the support surface 111a of the medium support unit 110a located at the end in the -X direction.

The end in the +X direction of the support surface 111 of the downstream unit 110 is located on the -X direction side with respect to the end in the +X direction of the support surface 106 of the upstream unit 105. The end in +X direction of the support surface 111 of the downstream unit 110 is the end in the +X direction of the support surface 111a of the medium support unit 110a located at the end in the +X direction.

Thus, a dimension W2 between both the ends in the X-axis direction of the support surface 111 of the downstream unit 110 is smaller than a dimension W1 between both the ends in the X-axis direction of the support surface 106 of the upstream unit 105. For that reason, in the width direction, a range in which the medium 22 is supported is also narrowed and the length of the end in the width direction of the medium 22 hanging downward is also increased.

As illustrated in FIGS. 4 to 7, an upstream end portion 112a, which is an upstream end in the discharge direction A, of the medium support unit 110a is coupled to the upper frame 151. An upstream end portion 112b, which is an upstream end in the discharge direction A, of the medium support unit 110b is coupled to the upper frame 151.

The coupling of the upstream end portions 112a and 112b and the upper frame 151 specifies the position in the X-axis direction of the upstream end of the downstream unit 110 with respect to the upstream unit 105 and the upper frame 151.

The upstream end portions 112a and 112b and the upper frame 151 are coupled to a degree for enabling a downstream end, which is the end downstream in the discharge direction A, of the downstream unit 110, to move in the X-axis direction with respect to an upstream end of the downstream unit 110.

A downstream end portion 113a, which is a downstream end in the discharge direction A, of the medium support unit 110a and a downstream end portion 113b, which is a downstream end in the discharge direction A, of the medium support unit 110b are coupled to the connecting unit 114. The connecting unit 114 includes a connecting member 115 and a supported section 116.

As illustrated in FIGS. 4 and 5, the connecting member 115 extends in the X-axis direction at a position in the -Z direction of the support surfaces 111a and 111b of the medium support units 110a and 110b. The connecting member 115 has a round bar shape. Downstream end portions 113a of medium support units 110a and downstream end portions 113b of medium support units 110b are coupled to the connecting member 115. Downstream end portions 113a and 113b of pluralities of medium support units 110a and 110b are connected to each other by the connecting member 115.

In the connecting member 115, the supported section 116 extending from the connecting member 115 to the -Z direction side is provided. That is, the supported section 116 is provided at the downstream end in the discharge direction A of the downstream unit 110. The supported section 116 includes supported sections 116R and 116L. The supported section 116R and the supported section 116L are provided in the connecting member 115 at an interval in the X-axis direction.

As illustrated in FIGS. 5 and 6, the supported section 116R is provided at a position adjacent to, in the +X direction, the downstream end portion 113a of the medium support unit 110a configuring the end in the -X direction of the downstream unit 110. The supported section 116L is provided at a position adjacent to, in the -X direction, the downstream end portion 113a of the medium support unit 110a configuring the end in the +X direction of the downstream unit 110.

The lower ends, which are ends on the -Z direction side, of the supported sections 116R and 116L are supported by receiving units 163R and 163L provided in the lower frame 161 configuring the leg unit 130. Thus, in the downstream unit 110 configuring the loading unit 101, the supported section 116 located at the downstream end in the discharge direction A is supported by the lower frame 161.

As illustrated in FIGS. 4, 5, and 6, the leg unit 130 supports the upstream unit 105 and the downstream unit 110 configuring the loading unit 101 and the downstream loading unit 170. The leg unit 130 includes a leg 131, the upper frame 151, and the lower frame 161.

The leg 131 includes legs 131R and 131L. The legs 131R and 131L include upper sections 132, lower sections 133, and pillar sections 134. The upper sections 132 extend in the discharge direction A.

The lower sections 133 extend in the Y-axis direction. The pillar sections 134 extend from the lower sections 133 in the +Z direction and connect the centers of the lower sections 133 and the centers of the upper sections 132. On the lower surfaces, which are the surfaces in the -Z direction, of the lower sections 133, casters 181 are provided at positions close to the end in the -Y direction and close to the end in the +Y direction.

The upper frame 151 and the lower frame 161 connect the leg 131R and the leg 131L. The leg 131R and the leg 131L are connected at an interval in the X-axis direction by the upper frame 151 and the lower frame 161.

The upper frame 151 extends in the X-axis direction. The upper frame 151 connects the upper sections 132 of the legs 131R and 131L to each other. The upper sections 132 of the legs 131R and 131L are connected to each other by the upper frame 151 at a position further on the upstream side than the center of the upper section 132 in the discharge direction A.

The lower frame 161 includes a coupling unit 162 and a receiving unit 163. The coupling unit 162 has a square bar shape extending in the X-axis direction. The coupling unit 162 of the lower frame 161 connects the lower sections 133 of the legs 131R and 131L to each other. The lower sections 133 of the legs 131R and 131L are connected to each other by the coupling unit 162 of the lower frame 161 at a position at the center of the lower section 133 in the Y-axis direction.

The receiving unit 163 extends in the +Y direction from the coupling unit 162. The receiving unit 163 receives the supported section 116 of the downstream unit 110. The receiving unit 163 includes receiving units 163R and 163L. The receiving unit 163R and the receiving unit 163L are disposed at an interval in the X-axis direction.

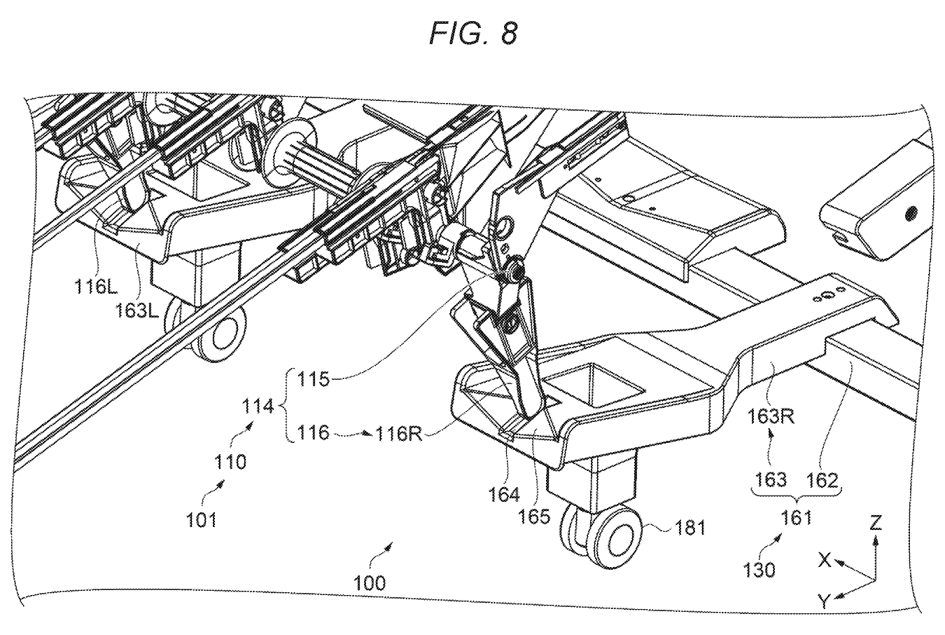

As illustrated in FIGS. 4 and 8, holding sections 164 and guiding sections 165 are provided at the ends in the +Y direction of the receiving units 163R and 163L. The casters 181 are provided at positions close to the ends in the +Y direction on the lower surfaces, which are the surfaces in the -Z direction, of the receiving units 163R and 163L.

The holding sections 164 are provided at the ends in the +Y direction of the receiving units 163R and 163L. The holding sections 164 are groove-shaped recesses extending in the Y-axis direction. When the lower ends of the supported sections 116R and 116L fit into the holding sections 164 of the receiving units 163R and 163L, the supported sections 116R and 116L are supported by the holding sections 164 from the -Z direction side.

When the lower ends of the supported sections 116R and 116L are supported by the holding sections 164 from the -Z direction side, the position in the Z-axis direction of the downstream end of the downstream unit 110 is specified. When the lower ends of the supported sections 116R and 116L fit into the holding sections 164 of the receiving units 163R and 163L, movement of the lower ends of the supported sections 116R and 116L in the X-axis direction is restricted.

When the movement of the lower ends of the supported sections 116R and 116L in the X-axis direction is restricted by a set restricting force, the position in the X-axis direction of the downstream end of the downstream unit 110 is specified. For example, when an external force equal to or greater than a set value in the X-axis direction acts on the downstream end of the downstream unit 110, the restriction force is set to a degree for allowing the lower ends of the supported sections 116R and 116L to come out of the holding section 164 in the X-axis direction. In other words, the receiving units 163R and 163L support the supported sections 116R and 116L to be movable in the X-axis direction.

The guiding sections 165 are inclined surfaces continuing from the openings of the holding sections 164 to both the outer sides in the X-axis direction and are inclined in a direction in which the positions thereof are higher as being away from the openings of the holding sections 164. The guiding sections 165 guide the lower ends of the supported sections 116R and 116L, which are in contact with the guiding sections 165, toward the holding sections 164.

For example, when an external force equal to or greater than a set value in the X-axis direction acts on the downstream end of the downstream unit 110, the lower ends of the supported sections 116R and 116L sometimes come out of the holding sections 164. The lower ends of the supported sections 116R and 116L come into contact with the guiding sections 165 according to the gravity even when coming out of the holding sections 164.

In this case, when no external force acts on the downstream end of the downstream unit 110, the lower ends of the supported sections 116R and 116L slide down toward the holding sections 164 along the guiding sections 165, which are inclined surfaces. Accordingly, when the lower ends of the supported sections 116R and 116L fit into the holding sections 164 again, the position in the X-axis direction of the downstream end of the downstream unit 110 is specified at the original position. Partition walls extending in the +Z direction may be provided at the end portions of the receiving units 163R and 163L in the X-axis direction such that the supported sections 116R and 116L on which the external force in the X-axis direction acts do not come off from the guiding sections 165.

As illustrated in FIGS. 6 and 7, the upper frame 151 is disposed vertically downward on the -Z direction side with respect to the support surface 106 of the upstream unit 105. The lower frame 161 is disposed on the +Y direction side, which is the downstream side in the discharge direction A, with respect to the upper frame 151.

The coupling unit 162 of the lower frame 161 is disposed vertically downward on the -Z direction side with respect to the support surface 111 of the downstream unit 110. The coupling unit 162 is disposed at a position in the -Z direction with respect to the upper frame 151. In the discharge direction A, the coupling unit 162 is disposed on the -Y direction side, which is the upstream side, with respect to the downstream end portions 113a and 113b, which are the downstream ends of the downstream unit 110.

As illustrated in FIG. 7, in the present embodiment, the distance in the Z-axis direction between the coupling unit 162 of the lower frame 161 and the support surface 111 of the downstream unit 110 is set to be longer than the distance in the Z-axis direction between the upper frame 151 and the support surface 106 of the upstream unit 105.

In this case, when a direction orthogonal to the discharge direction A and the X-axis direction is set as the up-down direction, the distance in the up-down direction between the lower frame 161 and the support surface 111 is longer than a distance D1 in the up-down direction between the upper frame 151 and the support surface 106. The distance in the up-down direction between the lower frame 161 and the support surface 111 is a distance D2 in the up-down direction between the lower frame 161 and the support surface 111a of the medium support unit 110a.

As illustrated in FIGS. 5 and 6, the leg 131R is disposed at an interval in the -X direction with respect to the end in the -X direction of the upstream unit 105. The leg 131L is disposed at an interval in the +X direction with respect to the end in the +X direction of the upstream unit 105.

The leg 131R is disposed at an interval in the -X direction with respect to the medium support unit 110a configuring the end in the -X direction of the downstream unit 110. The leg 131L is disposed at an interval in the +X direction with respect to the medium support unit 110a configuring the end in the +X direction of the downstream unit 110. Thus, the pair of legs 131R and 131L is disposed on both the sides of the loading unit 101 in the X-axis direction.

The medium 22 is discharged from the recording device 10 to the medium loading device 100 such that the end in the -X direction of the medium 22 (see the medium 22 indicated by an alternate long and two short dashes line in FIG. 6) passes a reference position in the X-axis direction regardless of the size of the medium 22. In the present embodiment, the position in the X-axis direction of the reference position is set to be substantially the same as the side surface in the +X direction of the upper section 132 of the leg 131R.

For this reason, regardless of the size of the medium 22, at least the end side in the -X direction of the medium 22 hangs to the outer side in the X-axis direction of the support surface 111. Accordingly, a curl formed at the leading end of the discharged medium 22 because of curling tendency or the like is eliminated.

In the present embodiment, a distance G1 in the X-axis direction between the end in the -X direction of the support surface 111 of the downstream unit 110 and the side surface in the +X direction of the upper section 132 of the leg 131R is set to be smaller than half of the dimension in the X-axis direction the discharged medium 22. Thus, the distance G1 is smaller than half of the width dimension of the smallest medium 22 among the discharged media 22.

The end in the -X direction of the support surface 111 is the medium support unit 110a at the end in the -X direction of the downstream unit 110. More specifically, the end in the -X direction of the support surface 111 is the end in the -X direction of the support surface 111a of the medium support unit 110a.

Accordingly, for example, even when the medium 22 has a small dimension in the X axis direction and only the end side in the -X direction hangs to the outer side in the X axis direction of the support surface 111, the medium 22 can be prevented from falling from the support surface 111 of the loading unit 101.

Further, the distance in the Z-axis direction between the coupling unit 162 of the lower frame 161 and the end in the -X direction of the support surface 111 is set to be longer than the distance G1. In this case, the distance in the up-down direction between the coupling unit 162 of the lower frame 161 and the end in the -X direction of the support surface 111 is longer than the distance G1.

The distance in the up-down direction between the lower frame 161 and the support surface 111 is the distance D2 in the up-down direction between the lower frame 161 and the support surface 111a of the medium support unit 110a illustrated in FIG. 7. Accordingly, it is possible to prevent the leading end of the medium 22 that has moved from the upstream unit 105 to the downstream unit 110 from curling again because the end of the medium 22 hanging to the outer side in the X-axis direction of the support surface 111 comes into contact with the lower frame 161.

As illustrated in FIGS. 3 and 4, the downstream loading unit 170 is continuously provided downstream in the discharge direction A of the downstream unit 110 and supports, on the support surface 171 from below, the medium 22 moving downstream in the discharge direction A from the downstream unit 110. The downstream loading unit 170 includes a plurality of medium support units 170a and 170b and a connecting unit 174.

The plurality of medium support units 170a and 170b have a square bar shape extending in the discharge direction A. The plurality of medium support units 170a and 170b are provided at intervals in the X-axis direction.

As illustrated in FIG. 6, in the present embodiment, three medium support units 170a and two medium support units 170b are provided at intervals in the X-axis direction. One medium support unit 170a among the three medium support units 170a is disposed at a position that continues to downstream in the discharge direction A of the medium support unit 110a at the center and is at the center of the downstream loading unit 170 in the X-axis direction.

One medium support unit 170b of the two medium support units 170b is disposed at a position that continues to downstream in the discharge direction A of one medium support unit 110b. The other medium support unit 170b of the two medium support units 170b is disposed at a position that continues to downstream in the discharge direction A of the other medium support unit 110b.

One medium support unit 170a among the three medium support units 170a is disposed at a position adjacent to one medium support unit 170b at an interval in the -X direction, the position being, in the X axis direction, the end in the -X direction of the downstream loading unit 170. One medium support unit 170a among the three medium support units 170a is disposed, in the X axis direction, between the medium support unit 110a at the end in the -X direction and one medium support unit 110b.

The remaining medium support unit 170a among the three medium support units 170a is disposed at a position that continues to downstream in the discharge direction A of the remaining medium support unit 110a disposed between the medium support unit 110a at the end in the +X direction and the other medium support unit 110b and is, in the X axis direction, the end in the +X direction of the downstream loading unit 170.

As illustrated in FIG. 7, the support surface 171 of the downstream loading unit 170 includes a support surface 171a, which is the surface on the +Z direction side, of the medium support unit 170a and a support surface 171b, which is a surface on the +Z direction side, of the medium support unit 170b.

The support surface 171a of the medium support unit 170a continues to downstream in the discharge direction A of the support surface 111a of the medium support unit 110a and extends in the discharge direction A. The support surface 171b of the medium support unit 170b continues to downstream in the discharge direction A of the support surface 111b of the medium support unit 110b and extends in the discharge direction A.

Thus, the support surface 171b of the medium support unit 170b is located further on the -Z direction side than the support surface 171a of the medium support unit 170a when viewed along the direction in the X-axis direction. The medium support units 170a and 170b and the support surfaces 171a and 171b of the medium support units 170a and 170b are inclined in a direction in which the downstream side in the discharge direction A is located further in the -Z direction than the upstream side.

As explained above, the support surface 171 of the downstream loading unit 170 in the present embodiment extends in the discharge direction A inclined in the direction in which the downstream side is located further in the -Z direction than the upstream side. For this reason, the medium 22 can be moved using the gravity. The medium 22 can be efficiently moved without using power or the like.

The downstream loading unit 170 includes the medium support unit 170a and the medium support unit 170b alternately at intervals in the X-axis direction. By alternately including the medium support units 170a and 170b, the downstream loading unit 170 can support the medium 22 sent from upstream to change into a corrugated shape when viewed from the direction in the discharge direction A.

Since the rigidity of the medium 22 is improved by changing the medium 22 sent from upstream into the corrugated shape, it is possible to suppress, in the discharge direction A, deterioration in conveyance due to deformation such as bending of the medium 22.

Accordingly, it is possible to prevent the conveyed medium 22 from being caught by the support surface 171 or the medium 22 already loaded on the support surface 171. Therefore, like the loading unit 101, various types of media 22 can be suitably loaded on the downstream loading unit 170 in the present embodiment without using power or the like.

As illustrated in FIG. 6, the end in the -X direction of the support surface 171 of the downstream loading unit 170 is located on the +X direction side with respect to the end in the -X direction of the support surface 111 of the downstream unit 110. The end in the -X direction of the support surface 171 is the medium support unit 170a at the end in the -X direction of the downstream loading unit 170. More specifically, the end in the -X direction of the support surface 171 is the end in the -X direction of the support surface 171a of the medium support unit 170a.

An end in the +X direction of the support surface 171 of the downstream loading unit 170 is located on the -X direction side with respect to an end in the +X direction of the support surface 111 of the downstream unit 110. The end in the +X direction of the support surface 171 is the medium support unit 170a at the end in the +X direction of the downstream loading unit 170. More specifically, the end in the +X direction of the support surface 171 is the end in the +X direction of the support surface 171a of the medium support unit 170a.

Thus, a dimension W3 between both the ends in the X-axis direction of the support surface 171 of the downstream loading unit 170 is smaller than the dimension W2 between both the ends in the X-axis direction of the support surface 111 of the downstream unit 110.

Upstream end portions 172a and 172b, which are upstream ends in the discharge direction A, of the medium support units 170a and 170b are coupled to the connecting member 115 of the downstream unit 110 to be capable of turning with the connecting member 115 extending in the X-axis direction as a rotation axis.

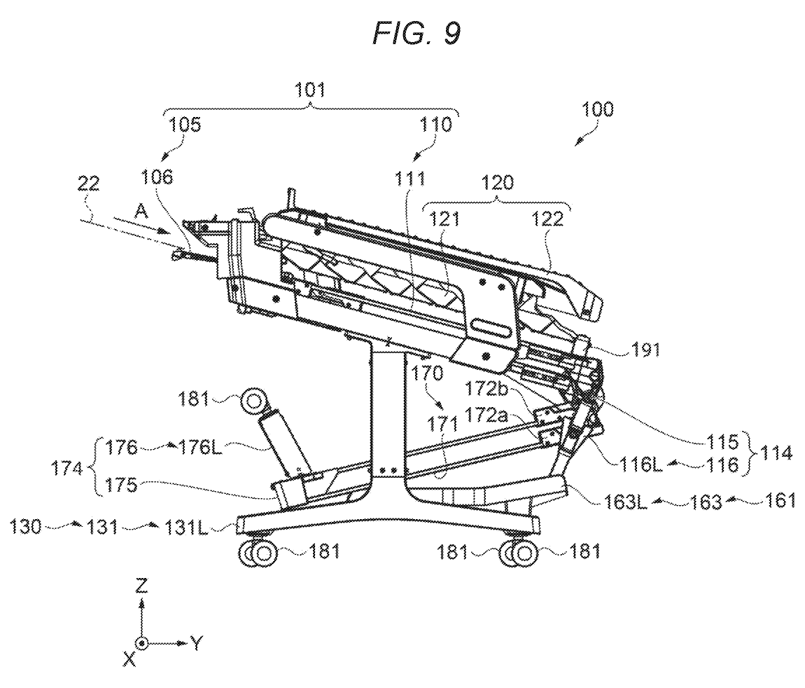

Accordingly, the downstream loading unit 170 is coupled to the downstream unit 110 of the loading unit 101 to be capable of moving to a loading position illustrated in FIGS. 2 to 7 and a housing position illustrated in FIG. 9 by turning with the connecting member 115 as the rotation axis.

The loading position is a position where the sent medium 22 can be loaded on the downstream loading unit 170. The housing position is a position where the downstream loading unit 170 is housed below the loading unit 101 by being turned with the connecting member 115 as the axis.

In other words, the downstream loading unit 170 is provided to be capable of being folded with respect to the loading unit 101 with the connecting member 115 as the axis. The medium loading device 100 in the present embodiment can load the medium 22 on the loading unit 101 even when the downstream loading unit 170 is present at the housing position.

As illustrated in FIG. 4, the downstream ends, which are downstream ends in the discharge direction A, of the medium support units 170a and 170b are coupled to the connecting unit 174. The connecting unit 174 includes a connecting member 175 and a support leg 176.

The connecting member 175 has a square bar shape extending in the X-axis direction. The downstream ends of the medium support units 170a and 170b are coupled to the connecting member 175. The downstream ends of the plurality of medium support units 170a and 170b are connected to each other by a connecting member 175.

In the connecting member 175, the support leg 176 extending in the -Z direction from the connecting member 175 is provided. The support leg 176 includes support legs 176R and 176L. The support leg 176R is provided near the end in the -X direction of the connecting member 175. The support leg 176L is provided near the end in the +X direction of the connecting member 175. The casters 181 are provided on the lower surfaces, which are the surfaces in the -Z direction, of the support legs 176R and 176L.

As illustrated in FIGS. 2 and 3, the pressing unit 120 includes pressing units 121 and 122. The pressing unit 121 is provided to be capable of coming into contact with, from the upper side, which is the +Z direction side, the medium 22 supported by the upstream unit 105 and the downstream unit 110 of the loading unit 101. The pressing unit 121 suppresses deformation such as a curl of the medium 22 within an allowable range by coming into contact with the medium 22 floating from the support surfaces 106 and 111.

The pressing unit 122 is provided to be capable of coming into contact with, from the upper side, which is the +Z direction side, the medium 22 supported by the downstream loading unit 170. The pressing unit 122 is provided at a downstream end in the discharge direction A of the pressing unit 121 to be capable of turning around a rotation axis extending in the X-axis direction.

The pressing unit 122 is capable of moving to a pressing position illustrated in FIG. 3 and the housing position illustrated in FIG. 9 by turning. The pressing unit 122 suppresses deformation such as a curl of the medium 22 within an allowable range by coming into contact with, at the pressing position, the medium 22 floating from the support surface 171. When the pressing unit 122 is turned to the housing position located above the pressing unit 121, the pressing unit 120 changes to a folded state.

The edge guide 191 is detachably provided in the downstream unit 110 or the downstream loading unit 170. The user can change the position in the discharge direction A of the edge guide 191. The edge guide 191 specifies the position of the leading end in the discharge direction A of the medium 22 sent to the loading unit 101 or the downstream loading unit 170.

For this reason, the medium loading device 100 in the present embodiment can suitably change the position of the edge guide 191 according to the size of the medium 22 in use and can suitably load the medium 22.

As explained above, with the medium loading device 100 according to the present embodiment, it is possible to obtain effects described below.

The medium loading device 100 is the medium loading device 100 on which the medium 22 discharged from the recording device 10 in the discharge direction A is loaded. The medium loading device 100 includes the loading unit 101 on which the medium 22 is loaded. In the loading unit 101, the medium 22 is loaded on the support surface 111 extending in the discharge direction A to suspend, downward from the support surface 111, at least one end in the X-axis direction intersecting the discharge direction A. The medium loading device 100 includes the pair of legs 131R and 131L disposed on both the sides in the X-axis direction with respect to the loading unit 101. The medium loading device 100 includes the upper frame 151 that extends in the X-axis direction and connects the pair of legs 131R and 131L. The medium loading device 100 includes the lower frame 161 that extends in the X-axis direction and connects the pair of legs 131R and 131L.

The lower frame 161 connects the pair of legs 131R and 131L at a position downstream in the discharge direction A with respect to a position where the upper frame 151 connects the pair of legs 131R and 131L. The loading unit 101 includes the upstream unit 105 including the upstream side in the discharge direction A of the support surfaces 106 and 111, the upstream unit 105 being supported by the upper frame 151. The loading unit 101 includes the downstream unit 110 including the downstream side in the discharge direction A of the support surfaces 106 and 111, the downstream unit 110 being supported by the lower frame 161.

When the direction orthogonal to the discharge direction A and the X-axis direction is set as the up-down direction, the distance D2 in the up-down direction between the support surface 111 of the downstream unit 110 and the lower frame 161 is longer than the distance D1 in the up-down direction between the support surface 106 of the upstream unit 105 and the upper frame 151. The downstream unit 110 is supported by the lower frame 161 from the -Z direction side via the supported sections 116R and 116L provided in the downstream unit 110.

Accordingly, it is possible to prevent the leading end of the medium 22 from curling again because the end of the medium 22 hanging to the outer side in the X-axis direction of the support surface 111 comes into contact with the lower frame 161. Thus, it is possible to reduce occurrence of a loading failure of the medium 22 in the loading unit 101 due to a curl formed at the leading end of the medium 22. Accordingly, it is possible to easily implement a configuration in which, in the up-down direction, the distance D2 between the support surface 111 of the downstream unit 110 and the lower frame 161 is longer than the distance D1 between the support surface 106 of the upstream unit 105 and the upper frame 151.

The lower frame 161 includes the receiving units 163R and 163L that support the supported sections 116R and 116L. The receiving units 163R and 163L support the supported sections 116R and 116L to be capable of moving in the X-axis direction. Accordingly, it is possible to alleviate an impact received by the loading unit 101 because of an external force acting on the downstream unit 110 from the X-axis direction.

The pair of legs 131R and 131L and the receiving units 163R and 163L include the casters 181. Accordingly, it is possible to easily move the medium loading device 100.

The downstream unit 110 includes the plurality of medium support units 110a and 110b extending in the discharge direction A and configuring the support surface 111. The plurality of medium support units 110a and 110b are disposed at intervals in the X axis direction. The medium support units 110a and 110b are connected to each other by the connecting member 115. Accordingly, it is possible to reduce the loading unit 101 in weight.

In the connecting member 115, the supported sections 116R and 116L supported by the lower frame 161 from the -Z direction side are provided. Accordingly, it is possible to collectively support the plurality of medium support units 110a and 110b.

The medium loading device 100 further includes the downstream loading unit 170 coupled to the connecting member 115 and extending in the discharge direction A following the downstream unit 110. The downstream loading unit 170 is capable of being folded with respect to the loading unit 101 with the connecting member 115 as the axis.

Accordingly, the medium loading device 100 can be, while being capable of loading the long medium 22, made compact by folding the downstream loading unit 170.

The medium loading device 100 according to the embodiment of the present disclosure basically has the configuration explained above. However, it is also naturally possible to make modifications, omissions, and the like of a part of the configuration without departing from the gist of the present disclosure. The embodiment explained above and other embodiments explained below can be combined with each other and implemented as long as no technical inconsistencies are involved. The other embodiments are explained below.

In the embodiment explained above, the dimension W2 between both the ends in the X-axis direction of the support surface 111 of the downstream unit 110 may not be smaller than the dimension W1 between both the ends in the X-axis direction of the support surface 106 of the upstream unit 105. For example, the dimension W1 may be the same as the dimension W2.

In the embodiment explained above, the dimension W3 between both the ends of the support surface 171 of the downstream loading unit 170 in the X-axis direction may not be smaller than the dimension W2 between both the ends of the support surface 111 of the downstream unit 110 in the X-axis direction. For example, the dimension W3 may be the same as the dimension W2.

In the embodiment explained above, the support surface 111 of the downstream unit 110 may not include the support surfaces 111a of the four medium support units 110a and the support surfaces 111b of the two medium support units 110b. For example, the support surface 111 may include support surfaces 111a of seven medium support units 110a and support surfaces 111b of five medium support units 110b. In this case, the support surface 171 of the downstream loading unit 170 may include support surfaces 171a of five medium support units 170a and support surfaces 171b of three medium support units 170b.

Alternatively, the support surface 111 of the downstream unit 110 may include any one of the medium support unit 110a and the medium support unit 110b. For example, the support surface 111 may include support surfaces 111a of six medium support units 110a. In this case, the positions in the up-down direction of the plurality of support surfaces 111a configuring the support surface 111 are the same. In this embodiment, the support surface 171 of the downstream loading unit 170 may include support surfaces 171a of six medium support units 170a. In this case, the positions in the up-down direction of the plurality of support surfaces 171a configuring the support surface 171 are the same.

In the embodiment explained above, the receiving units 163R and 163L of the lower frame 161 may not support the supported sections 116R and 116L of the downstream unit 110 to be capable of moving in the X-axis direction. For example, the supported sections 116R and 116L of the downstream unit 110 may be immovably fixed to the receiving units 163R and 163L of the lower frame 161.

In the embodiment explained above, the downstream loading unit 170 may not be coupled to the downstream unit 110 of the loading unit 101 to be capable of moving to the loading position and the housing position by turning with the connecting member 115 as the rotation axis. For example, the downstream loading unit 170 may be supported by the loading unit 101 to be capable of moving to the loading position where the sent medium 22 can be loaded and the housing position located below the loading unit 101 by moving in the discharge direction A.

What is claimed is:

1. A medium loading device on which a medium discharged from a processing device in a discharge direction is loaded, the medium loading device comprising:
a loading unit in which the medium is loaded on a support surface that supports the medium and extends in the discharge direction to suspend, downward from the support surface, at least one end of the medium in a width direction intersecting the discharge direction;
a pair of legs disposed on both sides in the width direction with respect to the loading unit;
an upper frame extending in the width direction and connecting the pair of legs to each other; and
a lower frame extending in the width direction and connecting the pair of legs to each other, wherein
the lower frame connects the pair of legs to each other at a position downstream in the discharge direction with respect to a position where the upper frame connects the pair of legs to each other,
the loading unit includes:
an upstream unit including an upstream side in the discharge direction in the support surface and supported by the upper frame; and
a downstream unit including a downstream side in the discharge direction in the support surface and supported by the lower frame,
when a distance orthogonal to the discharge direction and the width direction is set as an up-down direction, a distance in the up-down direction between the support surface of the downstream unit and the lower frame is longer than a distance in the up-down direction between the support surface of the upstream unit and the upper frame, and
the downstream unit is supported by the lower frame from a lower side via a supported section of the downstream unit.

2. The medium loading device according to claim 1, wherein
the lower frame includes a receiving unit configured to support the supported section, and
the receiving unit supports the supported section to be capable of moving in the width direction.

3. The medium loading device according to claim 2, wherein the pair of legs and the receiving unit include casters.

4. The medium loading device according to claim 1, wherein
the downstream unit includes a plurality of medium support units extending in the discharge direction and configuring the support surface
the plurality of medium support units are disposed at intervals in the width direction, and
the medium support units are connected to one another by a connecting member.

5. The medium loading device according to claim 4, wherein, in the connecting member, a supported section supported by the lower frame from the lower side is provided.

6. The medium loading device according to claim 4, further comprising a downstream loading unit coupled to the connecting member and extending in the discharge direction following the downstream unit, wherein
the downstream loading unit is capable of being folded with respect to the loading unit with the connecting member as an axis.
